(19) United States
(12) Patent Application Publication
(10) Pub. No.: US 2026/0057426 A1
(43) Pub. Date: Feb. 26, 2026

(54) METHODS FOR GROUP PURCHASE OF ACCESS TO INFORMATION

(71) Applicant: Mahmoud Shayeb, Homer Glen, IL (US)

(72) Inventor: Mahmoud Shayeb, Homer Glen, IL (US)

(21) Appl. No.: 19/328,140

(22) Filed: Sep. 13, 2025

Related U.S. Application Data
(63) Continuation of application No. 17/105,240, filed on Nov. 25, 2020, now Pat. No. 12,417,476.

(51) Int. Cl. G06Q 30/0601

(52) U.S. Cl. CPC G06Q 30/0605; G06Q 30/0609; G06Q 30/0611; G06Q 30/0627; G06Q 30/0635

(57) ABSTRACT

A computer-implemented system for group purchase of access to information. A seller uploads a product, specifies a total price, and defines product units. Buyers purchase one or more product units, and when all units are sold, the system provides an access key to the product. The system manages dynamic pricing, secondary markets, incentives, subscriptions, and multiple payment methods. Products support diverse formats and delivery across digital, broadcast, and physical channels. The platform includes buyer protections, seller tools, end-to-end payment handling, and third-party integrations.

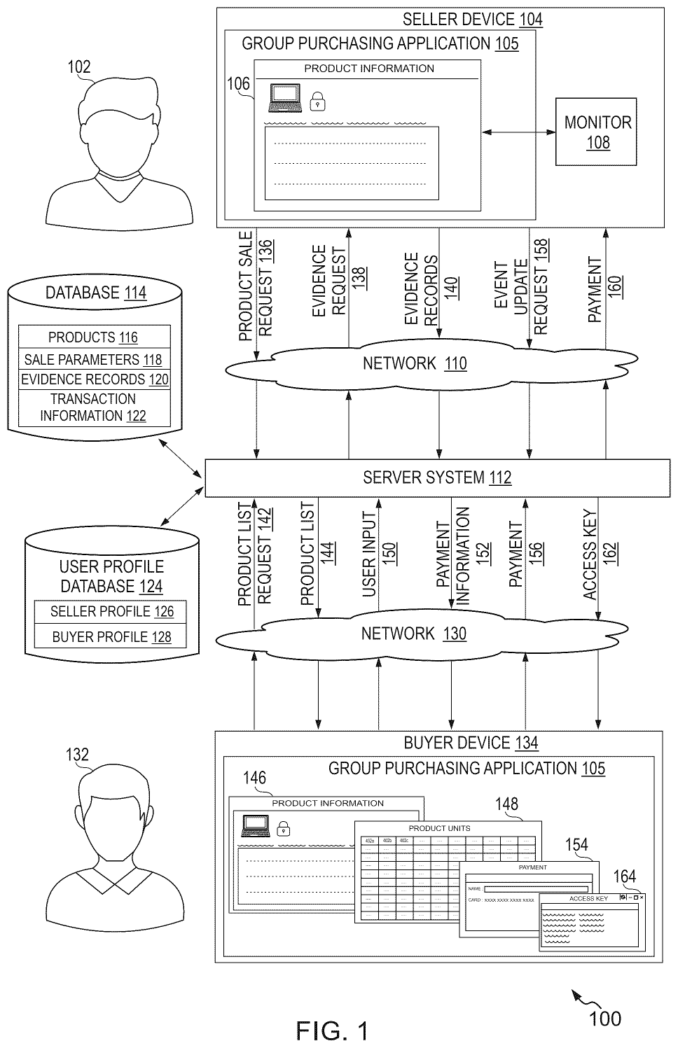

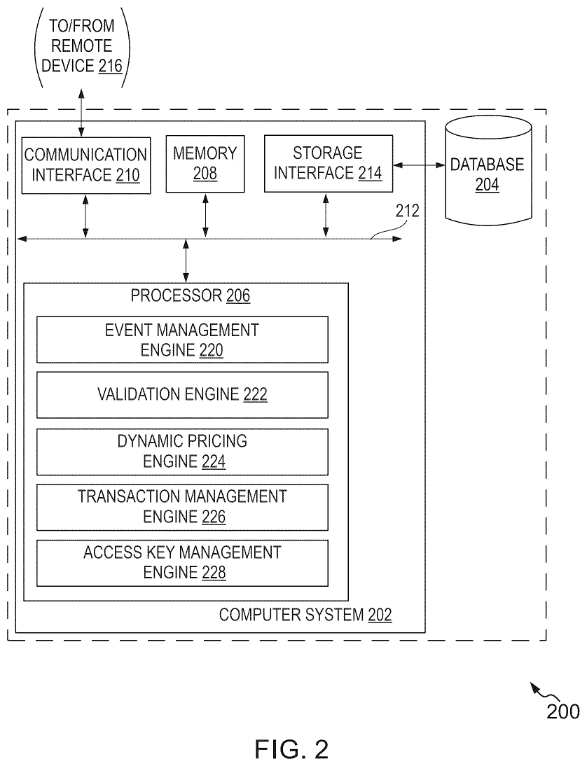

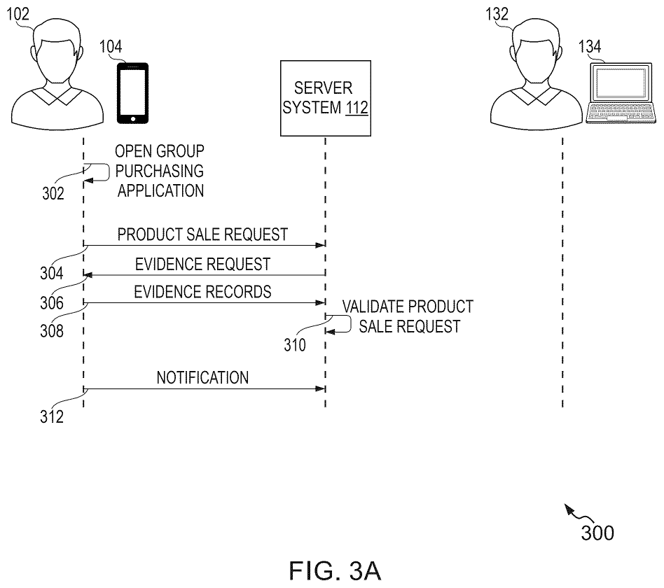

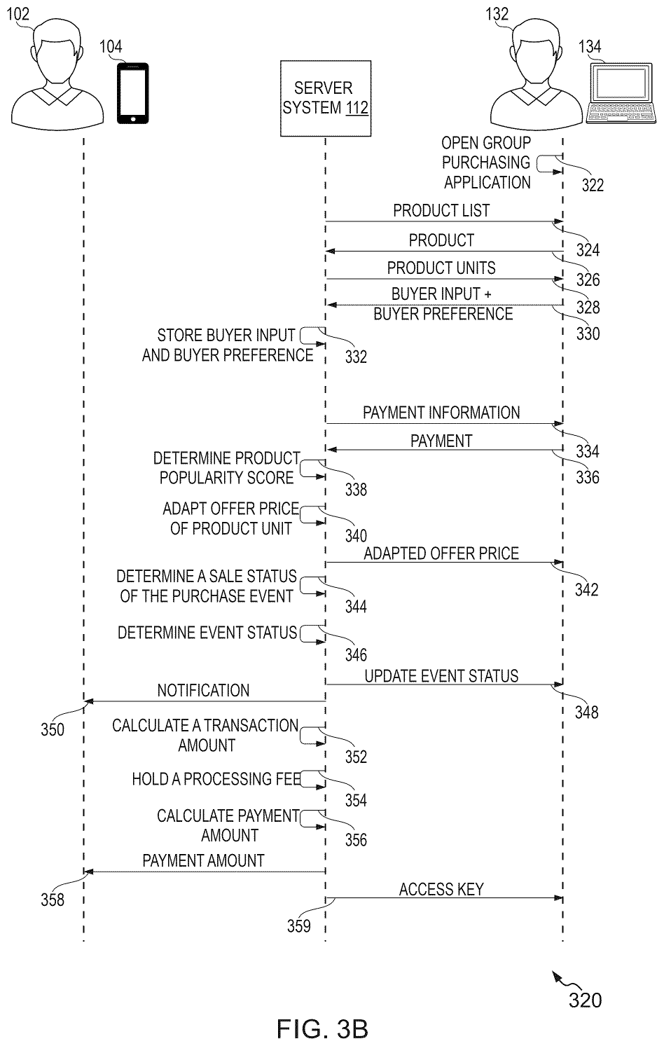

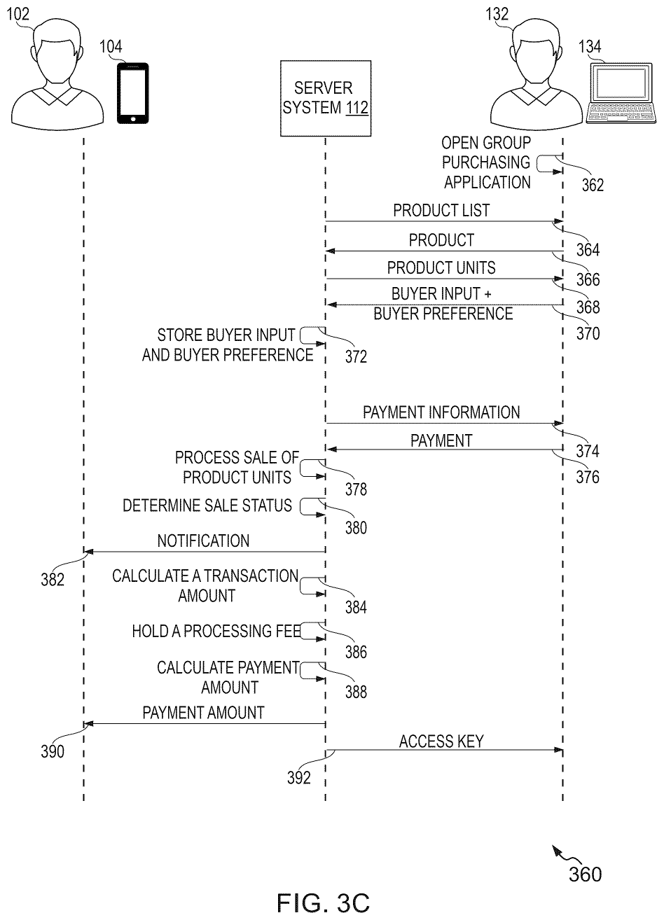

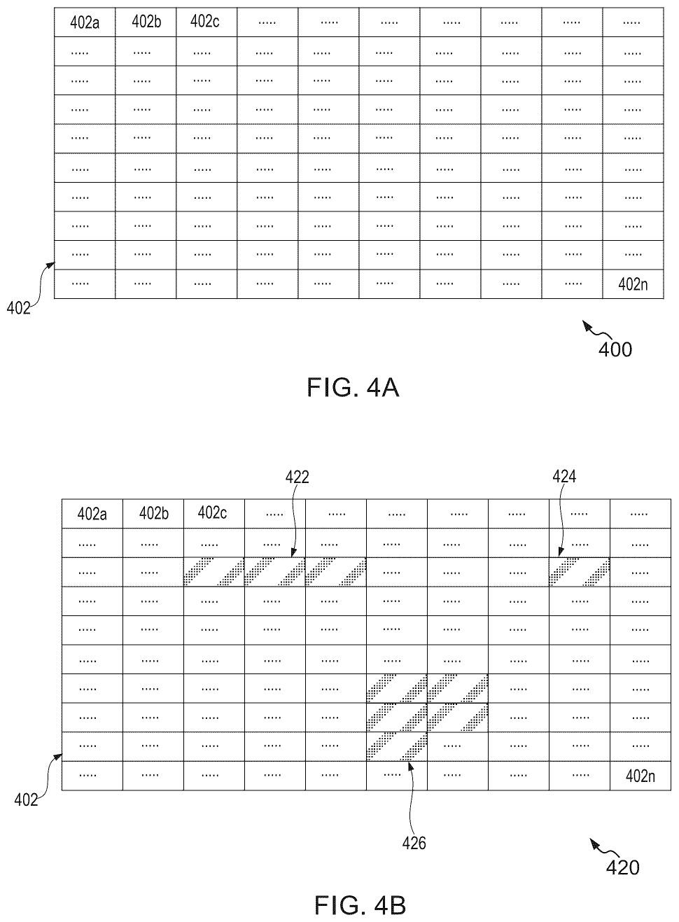

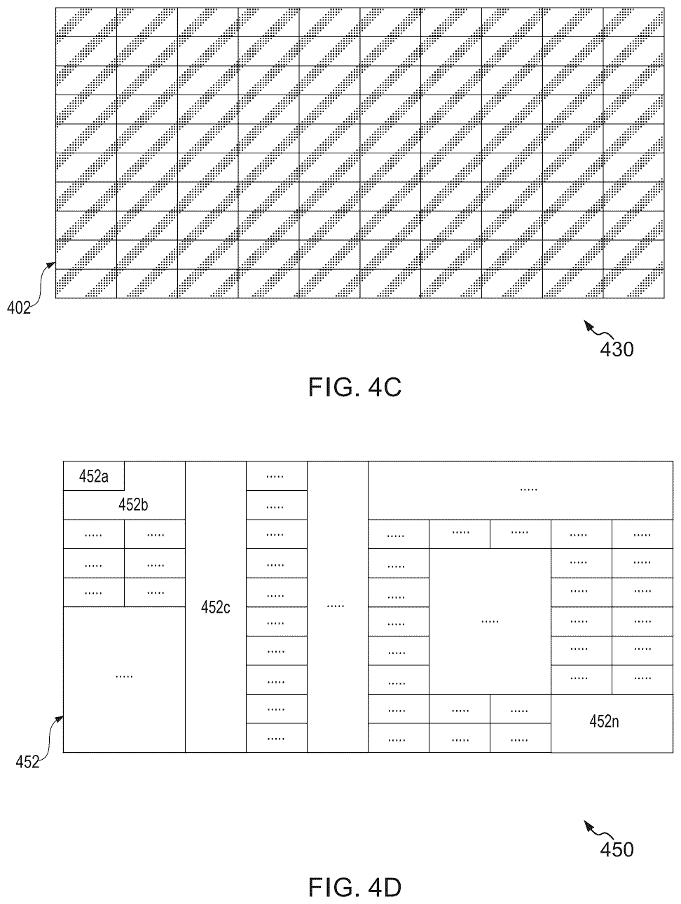

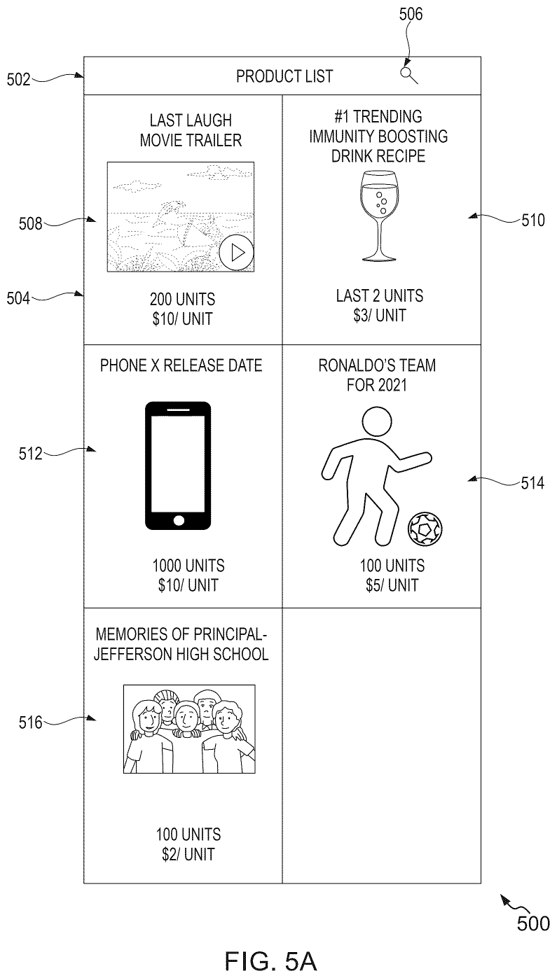

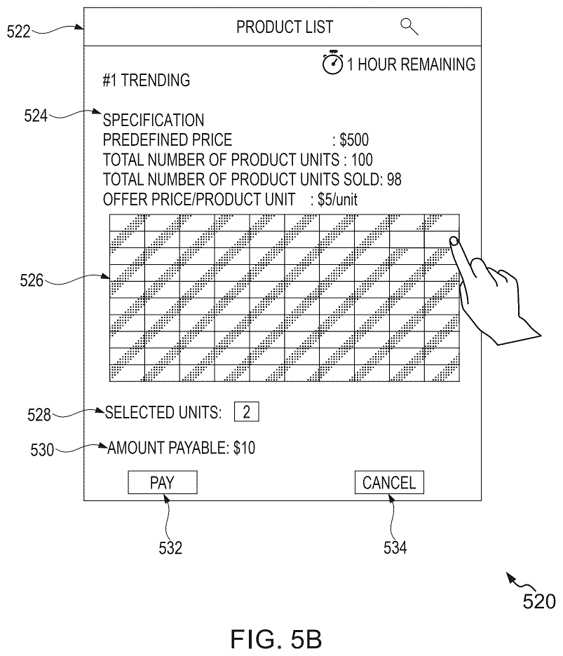

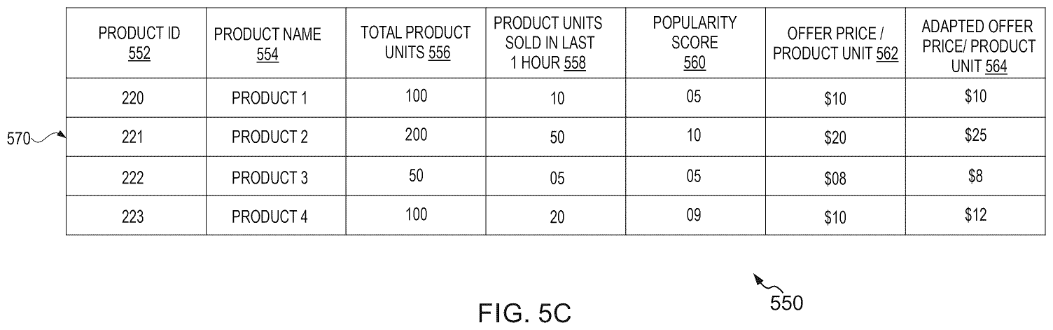

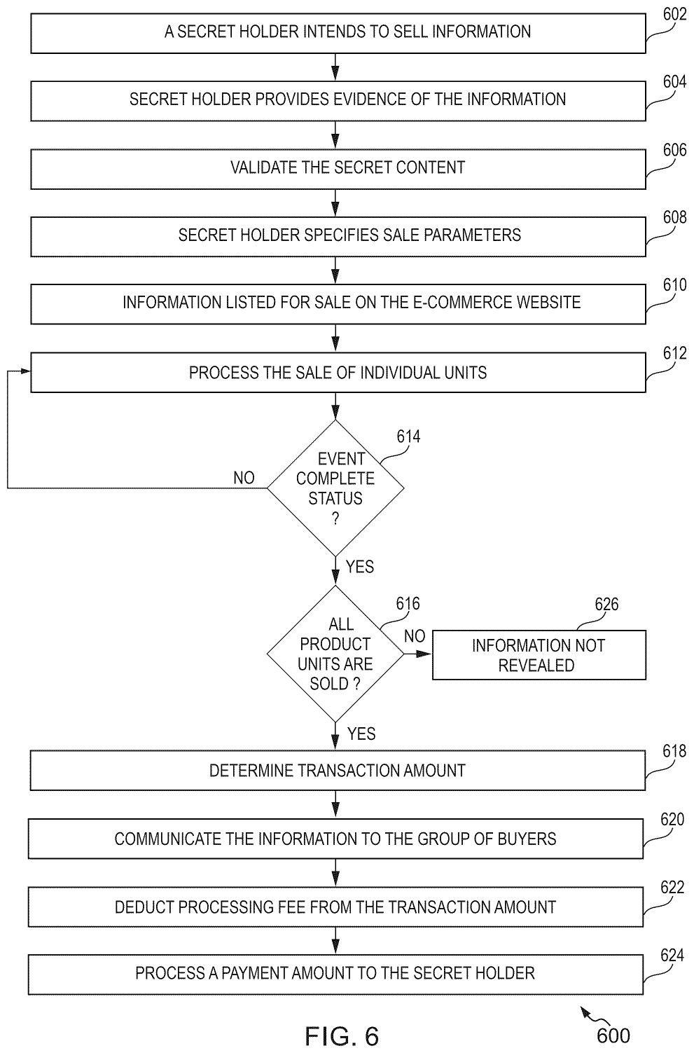

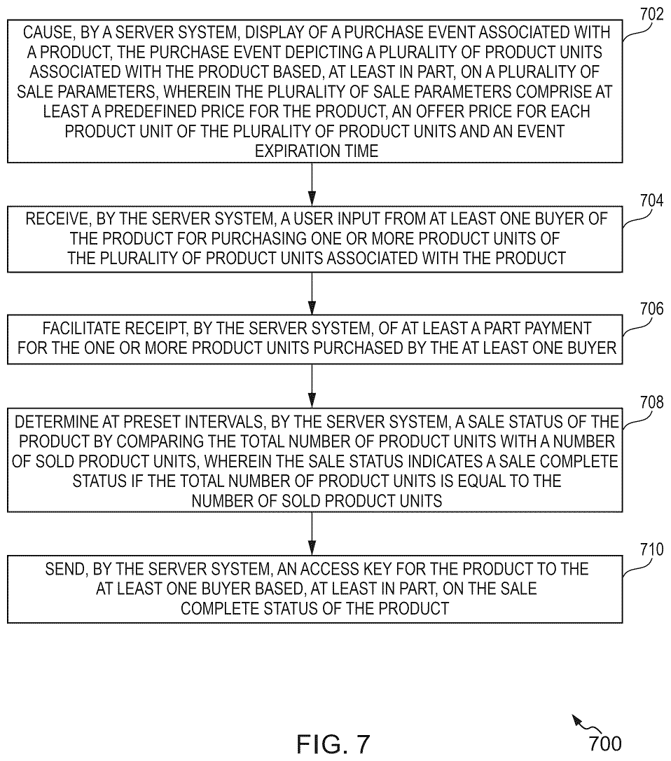

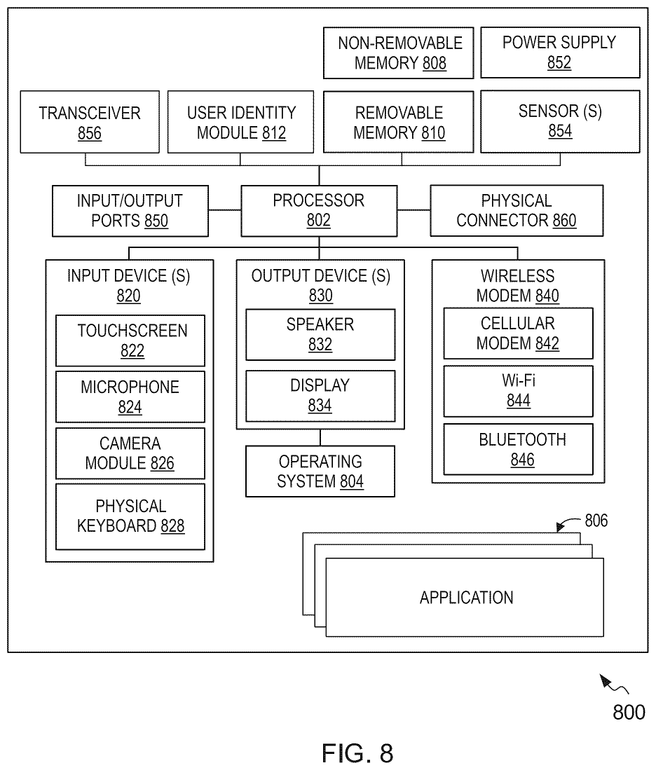

### BACKGROUND

The field relates to digital marketplaces and collective purchasing. Existing systems offer direct sales or basic crowdfunding. They lack controlled unit-based purchasing of confidential or undisclosed information products with flexible reveal conditions.

### SUMMARY

A server-based platform enables a seller to upload a product, divide it into product units, and set a total price. Buyers acquire units individually. The system computes unit price by dividing total price by units. When reveal conditions are satisfied, the system issues an access key to buyers. Enhancements include dynamic pricing, secondary markets, incentives, group goals, subscriptions, verification, flexible delivery, broad payment methods, buyer protections, seller dashboards, collaboration, AI personalization, and third-party integrations.

### DETAILED DESCRIPTION

Products. The product includes files, videos, images, audio, text, documents, source code, executable files, scripts, URLs, emails, SMS, QR codes, barcodes, coupon codes, license keys, API keys, blockchain tokens, encrypted tokens, passwords, geolocation, AR or VR objects, three-dimensional models, digital tickets, vouchers, streaming links, in-game assets, biometric data, or combinations. A product may expire after a set time and access keys are revoked.

Product units. The platform divides the product into product units. Buyers purchase one or more units. Units are equal or unequal, fractional or tiered, and priced dynamically as sales progress. A single buyer may purchase all units. Units are tradable in a rules-based secondary market.

Access keys and reveal. The system issues access keys when conditions are met. Reveal occurs when all units are purchased, at milestones, at scheduled times, by vote, or based on external triggers.

Payments. Payment methods include credit cards, Apple Pay, Google Pay, digital wallets, government-issued currency, cryptocurrency, bank transfer, cash, mobile carrier billing, loyalty points, rewards, and ad viewing. The system stores funds in escrow, digital wallets, banks, or blockchain and disperses proceeds upon reveal or refunds buyers if conditions are unmet. All transactions are logged immutably.

Buyer protections and access control. The system applies buyer-specific watermarking or encryption and enforces access rules by age, geography, gender, income, interests, demographics, language, device type, account history, or verification status.

Seller tools. Sellers configure listings, set prices, units, payments, and reveal conditions. Dashboards track sales, buyer activity, and revenue forecasts in real time. Sellers manage payouts, refunds, schedules, multiple campaigns, promotions, donations, discounts, incentives, and action logs.

Multiple sellers collaborate with predefined revenue splits. Subscriptions deliver recurring products to verified buyers. AI services generate or personalize products from seller instructions or buyer attributes.

Delivery channels. Access is delivered through secure downloads, in-app display, direct messages, SMS, email, push notifications, QR scans, coupon redemption, redirected links, APIs, streaming sessions, live video, augmented or virtual reality, physical printouts, integration with other applications, television broadcasts, radio, podcasts, social media, and live public announcements.

Integrations. APIs and widgets embed unit sales and access flows into e-commerce sites, social media platforms, gaming environments, and partner applications.

1. A computer-implemented system comprising: a server system having a processor, a memory, and a digital platform; wherein the digital platform enables a seller to upload a product and specify a total price and a number of product units into which the product is divided; wherein the system calculates a unit price by dividing the total price by the number of product units; wherein buyers may purchase one or more of the product units; and wherein the system provides an access key to the product when all of the product units are purchased.

2. The system of claim 1, wherein a single buyer purchases all of the product units and triggers immediate provision of the access key.

3. The system of claim 1, wherein the product units are of equal value or unequal value, and wherein the unit price changes dynamically over time.

4. The system of claim 1, wherein the product units include fractional units, premium-tier units, or units with prices that increase as additional units are sold.

5. The system of claim 1, wherein the access key is provided when all product units are purchased, in partial stages as funding milestones are reached, or upon satisfaction of outside conditions, scheduled times, buyer voting results, or promotional activity.

6. The system of claim 1, wherein the system provides a secondary marketplace in which product units are resold or traded, the secondary marketplace including rules for order types, automated pricing, escrow settlement, resale fees, and seller-defined price ranges.

7. The system of claim 1, wherein the system enforces early buyer incentives including discounts, bonus content, extra entries, priority access, referral multipliers, or reserved resale slots according to seller-defined rules.

8. The system of claim 1, wherein the product is unlocked when buyers collectively satisfy social sharing thresholds or group-funding goals, and wherein the system tracks external promotions and total buyer contributions toward unlock milestones.

9. The system of claim 1, wherein the product comprises at least one of: a file, a video, an image, an audio file, a text file, a document, source code, an executable file, a script, a URL, an email, an SMS message, a QR code, a barcode, a coupon code, an access key, a license key, an API key, a blockchain token, an encrypted token, a password, geolocation coordinates, an augmented or virtual reality object, a three-dimensional model, a digital ticket, a voucher, a streaming session link, an in-game digital asset, biometric data, or any combination thereof.

10. The system of claim 1, wherein the product expires after a predefined period following provision of the access key and the system automatically revokes access.

11. The system of claim 1, wherein the product is provided by at least one of: a secure download, an in-application display, a direct message, an SMS, an email, a push notification, a QR code scan, coupon redemption, a redirected link, an API call, a streaming session, a live video, an augmented reality display, a virtual reality display, a physical printout, integration with another application, broadcast television, radio, a podcast, a social media channel, or a live public announcement.

12. The system of claim 1, wherein buyers complete payment using at least one of: a credit card, Apple Pay, Google Pay, a digital wallet, government-issued currency, cryptocurrency, a bank transfer, cash, mobile carrier billing, loyalty points, rewards, ad viewing, or combinations thereof within a single purchase.

13. The system of claim 1, wherein the system applies buyer-specific protections including watermarking or encryption unique to each buyer and access restrictions based on at least one of age, geographic location, gender, income level, interests, demographics, language, device type, account history, or verification status.

14. The system of claim 1, wherein the system manages payments end-to-end by collecting funds through supported methods, storing funds in escrow accounts, digital wallets, banks, or blockchain ledgers, and dispersing proceeds to sellers, charities, or platform operators when reveal conditions are met, or refunding buyers if reveal conditions are unmet, with all transactions logged.

15. The system of claim 1, wherein access to the product is supported across communication channels including web browsers, mobile applications, SMS, MMS, email, instant messaging apps, push notifications, API integrations, smart televisions, television channels, radio, podcasts, social media platforms, in-game interfaces, kiosks, digital billboards, voice assistants, augmented reality devices, and virtual reality devices.

16. A computer-implemented system comprising: a server system configured to provide a seller interface; wherein the seller interface enables sellers to configure product listings, set prices, define product units, specify payment methods, and establish reveal conditions; wherein the seller interface provides dashboards to track sales progress, buyer activity, demographics, and revenue forecasts in real time; and wherein the seller interface enables sellers to manage payouts, refunds, scheduling, multiple concurrent campaigns, promotions, donations, discounts, incentives, and provides access to logs of seller actions for auditing and transparency.

17. The system of claim 16, wherein multiple sellers collaborate on a single product, the system dividing proceeds according to predefined percentages and permitting co-management of product creation, pricing, and reveal conditions.

18. The system of claim 16, wherein products are sold as a subscription or recurring series in which buyers purchase ongoing access to new products released periodically, access is restricted to verified buyers, and sellers offering subscription products are verified sellers identified by badges, checks, or indicators.

19. The system of claim 16, wherein products are listed by sellers through recording a selfie video, uploading a pre-recorded video, entering a written statement, or submitting other formats accepted by the system, and wherein the system supports automated or AI-based generation or personalization of products based on seller instructions or buyer attributes.

20. The system of claim 16, wherein the system integrates product sales into third-party platforms including e-commerce sites, social media channels, gaming platforms, or partner applications through application programming interfaces or widgets.
